(19) United States
(12) Patent Application Publication
(10) Pub. No.: US 2004/0230533 A1
(43) Pub. Date: Nov. 18, 2004

(54) Pro-rated consumable resource governor

(76) Inventor: David S. Benco, Winfield, IL (US)

Correspondence Address: PATTI & BRILL, ONE NORTH LASALLE STREET, 44TH FLOOR, CHICAGO, IL, 60602, US

(21) Appl. No.: 10/439,812

(22) Filed: May 16, 2003

(51) Int. Cl. G06F 17/60

(52) U.S. Cl. 705/63

(57) ABSTRACT

The method and apparatus is for allocating a fixed resource evenly over time in predetermined increments. One embodiment of the method has the steps of: receiving a resource request in a time increment; obtaining a resource limit; selecting a mode of operation; monitoring usage of the resource; calculating a quantity of usage of the resource; determining if a portion of the resource can be allocated based on the calculated quantity of the resource; granting the resource request for the time increment if the portion of the resource can be allocated; and denying the resource request for the time increment if the portion of the resource cannot be allocated. The apparatus implements the method.

### TECHNICAL FIELD

The present invention relates to allocation of resources in general, and, more particularly, to a method and system for allocating a fixed resource evenly over time in predetermined increments.

### BACKGROUND

Allocation of resources of all types to users is an important concept in operating a successful business. Resources may include electrical power, natural gas, central processing unit (CPU) cycles, capability of routing calls through a switch in a telecommunications network, etc.

One example of a resource is electrical power. One known method and system is for regulating power delivered to different commercial or residential users in which each user has variable demands for power consumption. In this system there is a power source from which power is transmitted by a utility to each user and a utility control signal, which is transmitted from the utility to each user in order to modify the power consumed by each user. The power consumption of each user is measured over a selected real time interval, and each user modifies the power consumption by an amount directly related to the power consumption measurement of each user over that time interval.

Another known electrical power controlling/load shedding system includes power consumption metering and meter interfacing circuitry for entering overall power consumption into a central processing unit (CPU). The CPU memory includes a data storage table characterizing each system electrical load under each of a hierarchy of operational levels, and circuitry is provided for turning local and remote loads on/off, responsive to CPU-issued commands. The digital computing apparatus operates on the meter supplied information and projects energy consumption over the monitoring interval. If power must be shed to obviate an excessive projected demand, loads are examined seriatim and selectively shed on a priority basis as required, depending upon the operational parameters and status characterizing each load for the then prevailing load level condition.

In a further known system electric power uses or loads in a premises are controlled or managed depending upon whether the use is for heating, hot water, heat pump, air conditioning, lights, appliances, pumps, etc. Programs are controlled by the electric Power company, for the purposes of spreading power uses at the premises over a day or other time interval, to avoid peak load periods encountered by the power company, while still providing the normal comfort levels required by the subscriber from the various power uses. Power levels of several uses at the subscriber's premises are sensed and the power for each use is controlled according to a program that includes a schedule of power level and/or the time of day that is inserted in the program or controlled in the program by the power company to accomplish the spreading. In a particular embodiment, a programmed computer unit is provided at the premises that are monitored by the power company via the subscribers' telephone line. Changes in the computer program are inserted in the unit by the power company, via the telephone line; and signals within and throughout the premises for detecting and controlling power uses are transmitted to and from the unit over the premises power line.

A load profile may depict, for example, electrical power that an electric power company supplies to industry, business and dwellings over a twenty-four hour period. Such a profile may reveal, as one example, an on-peak period beginning early in the morning at a level of, for example, 8,000 Megawatts, rising to a level of about 12,000 Megawatts by 11 o'clock AM and then dropping steadily to a level of about 11,000 Megawatts at mid afternoon, only to rise again to the level of 12,000 Megawatts again by 7 PM and thereafter drops throughout the evening and into the early hours of the next day to the 8,000 Megawatt level. Thus, there are two peaks during the day, one at about 11 AM and the other at about 7 PM; and during the off-peak period between 11 PM and 6 AM the next morning, the level falls well below 10,000 Megawatts.

This load profile tends to hold for most days of the year, although a load bias is imposed on particularly hot days when a great deal of air conditioning is demanded and on particularly cold days when electric heat demand is high. During such hot days, the total twenty-four hour period may be on peak, inasmuch as at all times the load profile is above the 10,000 Megawatt level.

Power companies presently lose millions of dollars each year from the theft of power by subscribers and those who have access to the power lines. The method of monitoring and verifying power use by industrial subscribers typically involves electronic meters with a remote sensing ability. Such meters are polled remotely via modems on existing phone lines. Currently, such remote sensing and polling systems are relatively expensive and are used only for industrial subscribers and not for dwellings or small businesses. Furthermore, such systems used for industrial subscribers have not been programmed with any particular effort to reduce power use during on-peak periods, or to spread power use over off-peak periods so that the power company load is spread more evenly over a twenty-four hour period.

These power control systems for industrial subscribers have been used primarily to inhibit theft of energy and have not been used to promote more economical use of energy or to help the power company achieve a more even load. Spreading the power loads of industrial subscribers more evenly over a twenty-four period, for many power companies, would not have much effect on the Power company's load profile. The reason for this is that for most power companies, by far the greater power load is not by industry and business, but by homes and dwellings. These prior monitoring systems used by industrial subscribers are too expensive for use in homes and dwellings. It is another object of the present invention to provide a relatively low cost controller for use in a home that is effective to shift several power uses therein from on-peak periods to off-peak periods without undue loss of subscriber comfort; and thereby spread power loads in the home more evenly over the twenty-four hour day, and at the same time provide monitoring by the Power company to inhibit power theft. Such a controller installed and operating in a large percentage of the dwellings serviced by a typical power company would have a very considerable impact on the daily load profile of the power company and would reduce and spread the on-peak loads.

Among other problems associated with conventional demand reduction schemes is that the utility only knows how much energy a customer uses, but not the rate of use or the demand of the customer use. As such, neither the utility nor the customer has accurate guidance with respect to proper setpoint selection or utility control. Further, utilities are in the business of selling energy. However, imposing arbitrary demand limits can only reduce the amount of energy sold during periods when demand control is not required. Still further, arbitrary and customer selectable demand control setpoints must be verified by installation of expensive meters which record the demand usage and which periodically must be read, reset and billed.

In the field of telecommunications, a resource may be a call capacity supplied by a telecommunications network to a user. It is a drawback that many times the supplier is unsure of the amount of call capacity that may be used by a user during a time period, and the user may not be able to predict the maximum number of calls that are placed during a time period.

### SUMMARY

The following summary of embodiments of the invention is provided to facilitate an understanding of some of the innovative features unique to the present invention and is not intended to be a full description. A full appreciation of the various aspects of the invention can be gained by taking the entire specification, claims, drawings, and abstract as a whole.

It is, therefore, one aspect of an embodiment of the present method and system to provide a method and system for allocating a fixed resource evenly over time in predetermined increments.

It is a further aspect of an embodiment of the present method and system to provide a method and system for allocating a fixed resource evenly over time in small increments.

It is a further aspect of an embodiment of the present method and system to provide a method and system that meters out an allocated capacity of a fixed resource such that purchase capacity is never exceeded.

Embodiments of the present method and apparatus provide an average time-increment quantity of a fixed resource and providing an amount of the fixed resource up to the average time increment quantity of the resource per time increment.

In very general terms in one embodiment of the method, the method has the steps of: receiving a resource request in a time increment; obtaining a resource limit; selecting a mode of operation; monitoring usage of the resource; calculating a quantity of usage of the resource; determining if a portion of the resource can be allocated based on the calculated quantity of the resource; granting the resource request for the time increment if the portion of the resource can be allocated; and denying the resource request for the time increment if the portion of the resource cannot be allocated.

In very general terms in one embodiment of the apparatus, the apparatus has: at least one fixed resource; evaluation system having an input for receiving a resource request, and having an output for outputting a control signal indicative of the resource request; operational mode system operatively connected to the evaluation system, and having an output for outputting mode parameter that is indicative of one of at least one mode of operation of the apparatus; monitoring system having an input for receiving at least one use parameter associated with use of the fixed resource, and having an output for outputting output data indicative of the use of the fixed resource; and metering system having inputs operatively coupled to the evaluation system, the operational mode system, and the monitoring system, the monitoring system operatively coupled to the fixed resource for controlling allocation of the fixed resource as a function of the control signal, the mode parameter, and the output data.

### BRIEF DESCRIPTION OF THE DRAWINGS

The accompanying figures, in which like reference numerals refer to identical or functionally-similar elements throughout the separate views and which are incorporated in and form part of the specification, further illustrate the present invention and, together with the detailed description of the invention, serve to explain the principles of the present invention.

FIG. 1 depicts a block diagram illustrative of the present method and system.

FIG. 2 illustrates a flow chart of logical operational steps that may be followed in accordance with one embodiment of the present method and system.

FIG. 3 illustrates a more general flow chart of logical operational steps that may be followed in accordance with one embodiment of the present method and system.

FIG. 4 depicts an embodiment in a telecommunications network.

FIG. 5 illustrates a flow chart of logical operational steps of an embodiment of the method implemented in the FIG. 4 network.

### DETAILED DESCRIPTION

The particular values and configurations discussed in these non-limiting examples can be varied and are cited merely to illustrate an embodiment of the present invention and are not intended to limit the scope of the invention.

An example of application of this invention in the wireless telecommunications field allocates Frame Selectors (FSs) on an as-needed basis for new calls. Certain types of calls require only one FS, whereas other call types (e.g., high-speed data calls) require several FSs. A wireless communications service provider typically purchases capacity in terms of maximum allowed FSs. For this example, the peak mode of operation of the invention would apply. A different licensing arrangement could specify the maximum total daily FS usage—in this case the daily mode of operation of the invention would apply and hourly limits would be calculated.

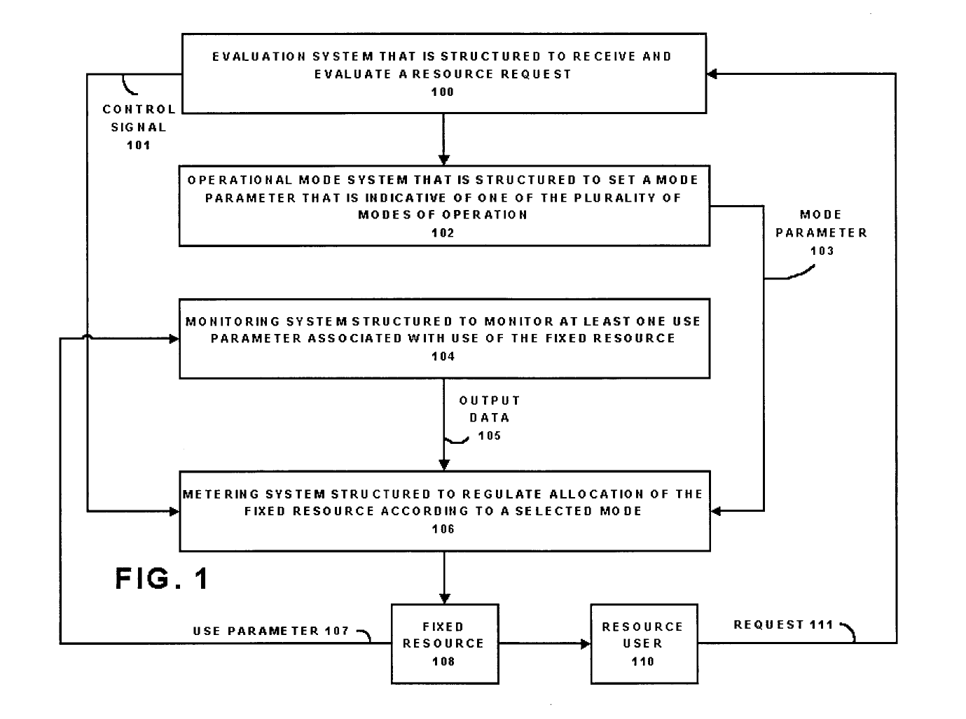

FIG. 1 depicts one embodiment of an apparatus for allocating a fixed resource evenly over time in predetermined increments. At least one fixed resource 108 is operatively connected to a resource user 110 and supplies a resource, such as electrical power, natural gas flow or call volume through a switch in a telecommunications system, to a resource user 110. The resource user 110, when the resource is desired, sends a resource request 111 to an evaluation system 100. The evaluation system 100 outputs a control signal 101 indicative of the resource request 111. An operational mode system 102 is operatively connected to the evaluation system 100, and outputs a mode parameter 103 that is indicative of one of at least one mode of operation of the apparatus. A monitoring system 104 receives at least one use parameter 107 associated with use of the fixed resource 108. The monitoring system 104 outputs output data indicative of the use of the fixed resource 108. A metering system 106 is operatively coupled to the evaluation system 100, the operational mode system 102, and the monitoring system 104. The monitoring system 106 is also operatively coupled to the fixed resource 108 for controlling allocation of the fixed resource 108 as a function of the control signal 101, the mode parameter 103, and the output data 105.

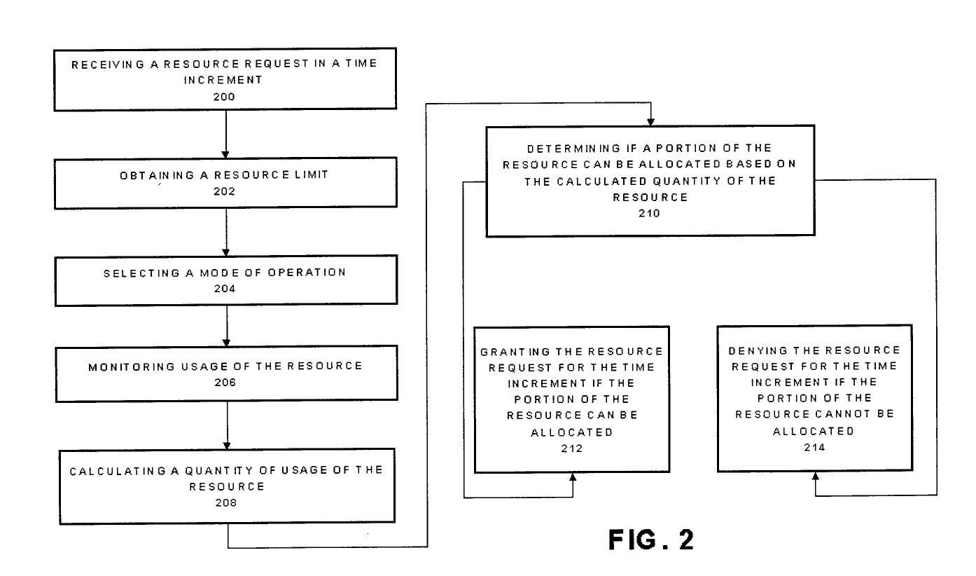

FIG. 2 depicts a general flow chart of an embodiment of a method for allocating a fixed resource over time in predetermined time increments. In this embodiment the method has the steps of: receiving a resource request in a time increment (step 200); obtaining a resource limit (step 202); selecting a mode of operation (step 204); monitoring usage of the resource (step 206); calculating a quantity of usage of the resource (step 208); determining if a portion of the resource can be allocated based on the calculated quantity of the resource (step 210); granting the resource request for the time increment if the portion of the resource can be allocated (step 212); and denying the resource request for the time increment if the portion of the resource cannot be allocated (step 214).

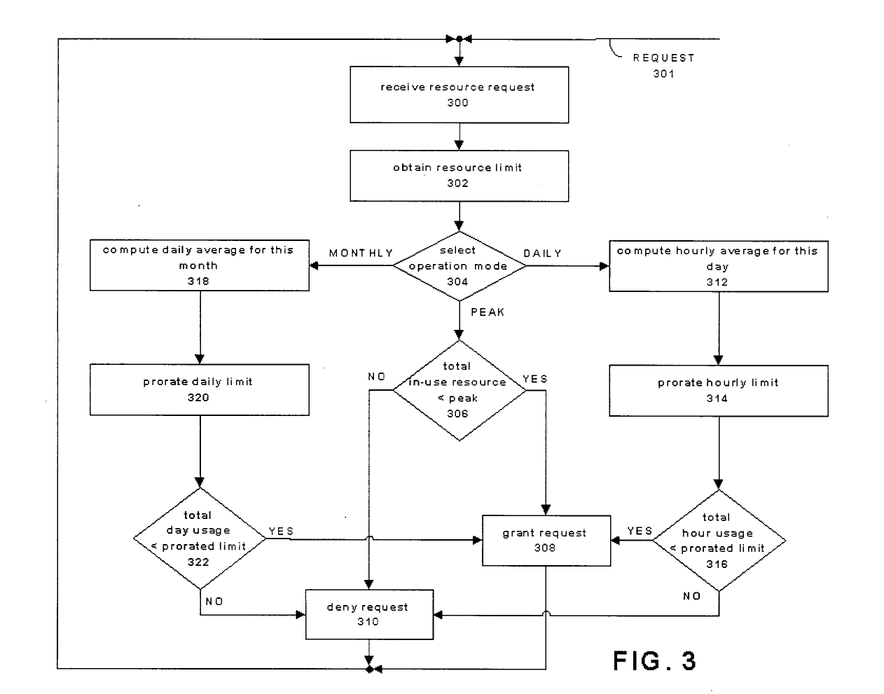

FIG. 3 depicts a more detailed flow chart of one embodiment of the method for allocating a fixed resource over time in predetermined time increments. In this embodiment a resource request 301 is received (step 300) and a resource limit is obtained (step 302). An operational mode is selected (step 304) for a monthly 301 mode, a daily mode 303, or a peak mode 305. For example for electrical power, in the monthly mode electrical power is supplied to a user one a day by day basis, in the daily mode electrical power is supplied to the user on an hour by hour basis, and in the peak mode electrical power is supplied to the user as a function of a peak load.

For monthly operation, a daily average of use of the resource is computed for the current month (step 318), and a daily limit is prorated (step 320). If the total day usage is less than the prorated limit (step 322), the request 301 is granted (step 308). For example, the user would be supplied with electrical power. If the total day usage is not less than the prorated limit, the request 301 is denied (step 310), and the user is denied service.

For daily operation, an hourly average of use of the resource is computed for the current day (step 312), and an hourly limit is prorated (step 314). If the total hour usage is less than the prorated limit (step 316), the request 301 is granted (step 308). For example, the user would be supplied with electrical power. If the total hour usage is not less than the prorated limit, the request 301 is denied (step 310), and the user is denied service.

For peak operation, if the total in-use resource is less than the peak limit (step 306), the request 301 is granted (step 308). For example, the user would be supplied with electrical power. If the total in-use resource is not less than the peak limit, the request 301 is denied (step 310), and the user is denied service.

An example of application of an embodiment of this invention in the wireless telecommunications field allocates Frame Selectors (FSs) on an as-needed basis for new calls. Certain types of calls require only one FS, whereas other call types (e.g., high-speed data calls) require several FSs. A wireless communications service provider typically purchases capacity in terms of maximum allowed FSs. For this example, the peak mode of operation of this embodiment of the invention would apply. A different licensing arrangement could specify the maximum total daily FS usage. In this case the daily mode of operation of the invention would apply and hourly limits would be calculated.

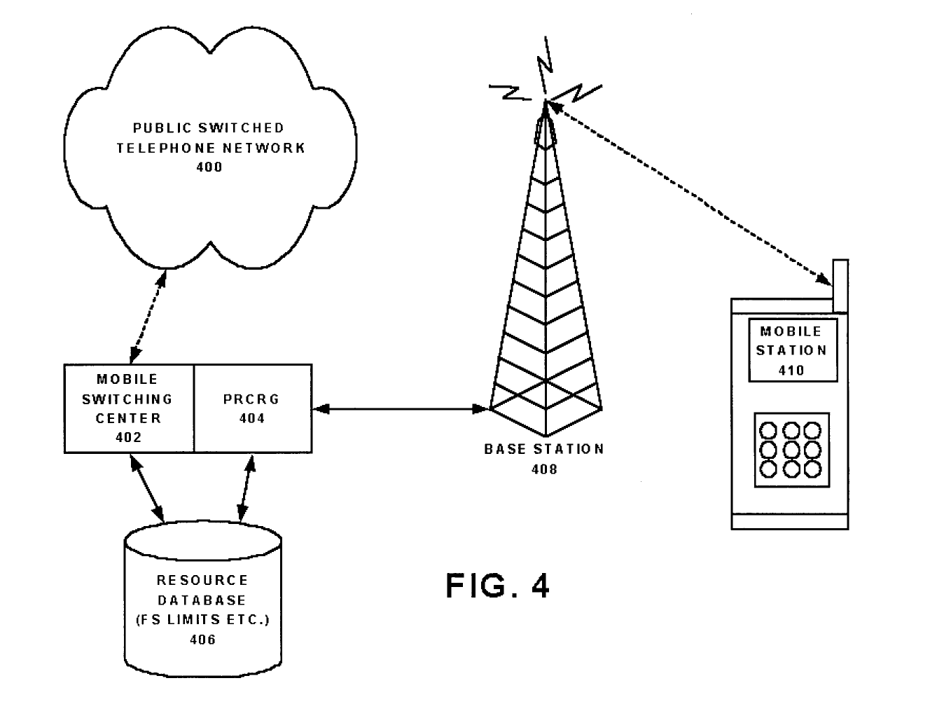

FIG. 4 depicts an embodiment in a telecommunications network wherein a public switched telephone network 400 is operatively connected to a mobile switching center 402. The mobile switching center 402 has a Pro-Rated Consumable Resource Governor (PRCRG) 404, each of which are operatively connected to a resource database 406 that stores FS limits, etc. The PRCRG 404 is operatively connected to a base station 408, which communicates with a mobile station 410.

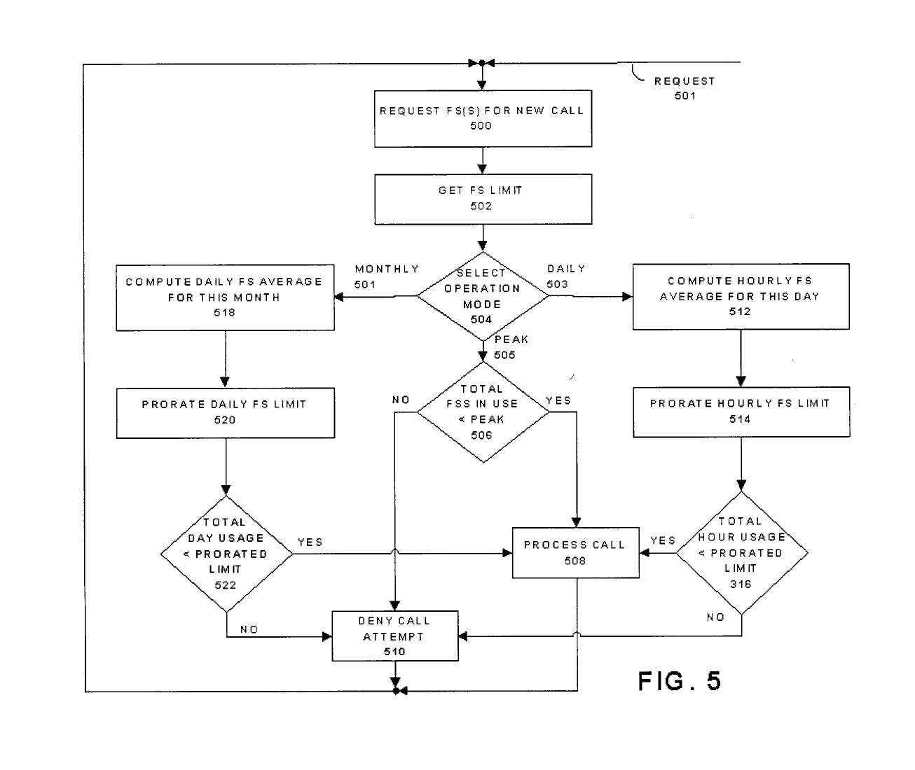

The method depicted in FIG. 5 is implemented in the FIG. 4 system. In this embodiment a resource request 501 is received (step 500) wherein the request is made to FSs for a new call, and a FS limit is obtained (step 502). An operational mode is selected (step 504) for a monthly 501 mode, a daily mode 503, or a peak mode 505.

For monthly operation, a daily FS average of use of the resource is computed for the current month (step 518), and the daily FS limit is prorated (step 520). If the total day usage is less than the prorated limit (step 522), the request 501 is granted and the call is processed(step 508). If the total day usage is not less than the prorated limit, the request 301 is denied and the call attempt is denied (step 510).

For daily operation, an hourly FS average of the resource is computed for the current day (step 512), and an hourly FS limit is prorated (step 514). If the total hour FS usage is less than the prorated limit (step 516), the request 501 is granted and the call is processed (step 508). If the total hour FS usage is not less than the prorated limit, the request 501 is denied and the call attempt is denied (step 510).

For peak operation, if the total FSs in use is less than the peak limit (step 506), the request 501 is granted and the call is processed (step 508). If the total FSs in use is not less than the peak limit, the request 501 is denied and the call attempt is denied (step 510). The present system and method may be used with various types of resources, such as, electrical power, natural gas, central processing unit (CPU) cycles, capability of routing calls through a switch in a telecommunications network, etc.

The method and system of the present invention may be implemented in hardware, software, or combinations of hardware and software. In a software embodiment, portions of the present invention may be computer program products embedded in computer readable medium. Portions of the system may employ and/or comprise a set and/or series of computer instructions written in or implemented with any of a number of programming languages, as will be appreciated by those skilled in the art.

Therefore, embodiments of the present method and system overcome the drawbacks of the prior art and provide a method and system that allocates a fixed resource evenly over time in predetermined increments. The present method and system also overcome the prior art drawback that many times the supplier is unsure of the amount of call capacity that may be used by a user during a time period, and that the user may not be able to predict the maximum number of calls that are placed during a time period.

The embodiments and examples set forth herein are presented to best explain the present invention and its practical application and to thereby enable those skilled in the art to make and utilize the invention. Those skilled in the art, however, will recognize that the foregoing description and examples have been presented for the purpose of illustration and example only. Other variations and modifications of the present invention will be apparent to those of skill in the art, and it is the intent of the appended claims that such variations and modifications be covered. The description as set forth is not intended to be exhaustive or to limit the scope of the invention. Many modifications and variations are possible in light of the above teaching without departing from the scope of the following claims. It is contemplated that the use of the present invention can involve components having different characteristics. It is intended that the scope of the present invention be defined by the claims appended hereto, giving full cognizance to equivalents in all respects.

The embodiments of the invention in which an exclusive property or right is claimed are defined as follows. Having thus described the invention what is claimed is:

1. A method for allocating a fixed resource evenly over time in predetermined increments, said method comprising the steps of:
providing an average time increment quantity of a fixed resource; and
providing an amount of the fixed resource up to the average time increment quantity of the resource per time increment.

2. The method of claim 1 further comprising the step of monitoring a single parameter to determine an average time increment quantity of the fixed resource.

3. The method of claim 1 wherein the parameter comprises one of electrical power usage, gas flow, number of central processing unit cycles, computer memory usage, and level of call volume.

4. The method of claim 1 wherein the fixed resource comprises one of electrical power, natural gas, central processing unit cycles, computer memory, and call volume.

5. The method of claim 1, wherein the method further comprises selecting one of a plurality of modes of operation, and wherein the provided amount of the fixed resource is allocated according to the selected mode of operation.

6. The method of claim 5 wherein the modes of operation comprise a daily mode, a monthly mode, and a peak mode.

7. A method for allocating a fixed resource over time in predetermined time increments, said method comprising the steps of:
receiving a resource request in a time increment;
obtaining a resource limit;
selecting a mode of operation;
monitoring usage of the resource;
calculating a quantity of usage of the resource;
determining if a portion of the resource can be allocated based on the calculated quantity of the resource;
granting the resource request for the time increment if the portion of the resource can be allocated; and
denying the resource request for the time increment if the portion of the resource cannot be allocated.

8. The method of claim 7 wherein the quantity of usage is representative of one of electrical power usage, gas flow, number of central processing unit cycles, computer memory usage, and level of call volume.

9. The method of claim 7 wherein the fixed resource comprises one of electrical power, natural gas, central processing unit cycles, computer memory, and call volume.

10. The method of claim 7 wherein a single parameter of the resource is monitored.

11. The method of claim 7, wherein the method further comprises selecting one of a plurality of modes of operation, and wherein the provided amount of the fixed resource is allocated according to the selected mode of operation.

12. The method of claim 11 wherein the modes of operation comprise a daily mode, a monthly mode, and a peak mode.

13. An apparatus for allocating a fixed resource evenly over time in predetermined increments, said apparatus comprising:
at least one fixed resource;
evaluation system having an input for receiving a resource request, and having an output for outputting a control signal indicative of the resource request;
operational mode system operatively connected to the evaluation system, and having an output for outputting mode parameter that is indicative of one of at least one mode of operation of the apparatus;
monitoring system having an input for receiving at least one use parameter associated with use of the fixed resource, and having an output for outputting output data indicative of the use of the fixed resource; and
metering system having inputs operatively coupled to the evaluation system, the operational mode system, and the monitoring system, the monitoring system operatively coupled to the fixed resource for controlling allocation of the fixed resource as a function of the control signal, the mode parameter, and the output data.

14. The apparatus of claim 13 wherein the fixed resource comprises one of electrical power, natural gas, central processing unit cycles, computer memory, and call volume.

15. The apparatus of claim 13 wherein the use parameter comprises one of electrical power usage, gas flow, number of central processing unit cycles, computer memory usage, and level of call volume.

16. The apparatus of claim 13, wherein the apparatus has a plurality of modes, and wherein the operational mode system sets a mode parameter that is indicative of one of the plurality of modes of operation of the apparatus.

17. The apparatus of claim 16 wherein the modes of operation comprise a daily mode, a monthly mode, and a peak mode.

18. A method for allocating a fixed resource in a telecommunications network over time in predetermined time increments, said method comprising the steps of:
receiving a call request in a time increment and requesting FSs for new call;
obtaining a FS limit;
selecting a mode of operation;
monitoring usage of the FS;
calculating a quantity of usage of the FS;
determining if a portion of the FS can be allocated based on the calculated quantity of the FS;
granting the request for the time increment if the portion of the FS can be allocated; and
denying the request for the time increment if the portion of the FS can not be allocated.

19. The method of claim 18, wherein the method further comprises selecting one of a plurality of modes of operation, and wherein the provided amount of the fixed resource is allocated according to the selected mode of operation.

20. The method of claim 19 wherein the modes of operation comprise a daily mode, a monthly mode, and a peak mode.
